(19) United States
(12) Patent Application Publication
(10) Pub. No.: US 2006/0023861 A1
(43) Pub. Date: Feb. 2, 2006

(54) Effecting VPN capability among wireless subscribers

(76) Inventor: Greg Carlson, Mississauga (CA)

Correspondence Address: Greg Carlson, 720 Dolly Bird Lane, Mississauga, ON, L5W1C7, CA

(21) Appl. No.: 10/898,953

(22) Filed: Jul. 27, 2004

(51) Int. Cl. H04M 7/00

(52) U.S. Cl. 379/221.15; 379/229

(57) ABSTRACT

The disclosure of present relates to art directed at effecting VPN capability among wireless users and subscribers. The teachings remain directed at voice, SMS, MMS, and data flows and generally towards any addressable wireless communication(s). Indeed, particularly (though not necessarily) aimed at corporate users, the invention permits for greater, more efficient and more economical usage of wireless communications.

### CROSS-REFERENCE TO RELATED APPLICATIONS

Patent application Ser. No. 10/353,995 entitled “Improved Method and System for Short Message Service (SMS) Rating and Billing”.

Patent application Ser. No. 10/461,485 entitled “Improved Method and System for Multimedia Messaging Service (MMS) Rating and Billing”.

Patent application Ser. No. 10/348,972 entitled “Method for implementing an Internet Protocol (IP) charging and rating middleware platform and gateway system”.

Patent application Ser. No. 10/307,335 entitled “Improved method for implementing an Open Charging (OC) middleware platform and gateway system”.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND ART

The art of present is aimed at disclosing means for telecommunications service providers (and like entities) the ability to offer voice-based or text-based or multi-media based virtual private networking features to their corporate wireless customers in particular (or generally to any subscriber(s) who may require like functionality/service). The invention is implemented as part of a computer program product, and does not require telecommunications service providers to purchase additional hardware, nor otherwise materially augment their existing infrastructures in putting it into practice. In that light, we remain unaware of any existing art which discloses like teachings, and in particular, any such invention which is implemented as part of a computer program product.

### REFERENCES CITED

None cited.

### TECHNICAL FIELD

The present invention relates generally to telecommunications network implementations relating to virtual private network (VPN) technologies; and in particular, to effecting VPN capability among wireless subscribers.

### SUMMARY OF THE INVENTION

The disclosed invention for effecting VPN capability among wireless subscribers provides telecommunication's service providers (and like entities) with the art to offer voice-based, text-based, and/or multi-media-based virtual private networking features to their corporate customers in particular. Customer Private Branch Exchanges (PBXs) connected via European Telecommunications Standards Institute (ETSI)/American National Standards Institute (ANSI) Primary Rate Interface (PRI) (for instance) to the Mobile Switching Center Service Switching Point MSC SSP) and mobile handsets may be grouped into the same VPN business groups and offered a uniform dial plan, onnet/offnet billing, and aggregate billing numbers among other features. Practitioners and other honourable members skilled in the art will recognize that a variety of protocols and like logical instructions may be employed apart from ETSI/ANSI PRI without diluting the intent and scope of the invention of present, and its inclusion herewith serves merely for the purpose of elucidation, simplicity and ease of instruction.

Offnet VPN access from the PSTN is also supported for Open Numbering Plans (ONP).

The invention provides considerable many VPN features (as Centralized Dialing Plan, Extension Dialing, Enhanced Dialing (e.g. Mobile, PSTN, Fax), DPN/Time-based Call Screening, Personal Account Prefix, Inter-Group VPN) to mobile handsets and PBX sites located at different geographic locations. The invention also provides art relating to zone based billing, which allows for billing based up on the location of the VPN subscriber. In some embodiments, distinct tones are provided to caller when situated in one of their home zones. The invention has also been articulated, in further optional embodiments, to provide for VPN interworking with prepaid service and prepaid account on the SCP.

The invention, for instance, permits members of a business group to reach one another using voice or messaging technologies (as SMS, MMS and so forth) by dialing private dial plan extensions from either a mobile handset, PBX extension (GSM only), or from the PSTN (GSM only).

Alternatively, when the public number of other VPN business group members are programmed into the handset's SIM, the service can recognize that the dialed number is an OnNet number (i.e. within the same business group) even though the public number of the CalledPartyNumber was received. In such cases, these calls attract a differentiated tariff rate (e.g. lower) from the service provider. When the call is an OffNet call (i.e. call placed to someone outside the caller's business group) then the calltype is set to OffNet, thereby typically attracting rates more expensive than OnNet calls.

If the CalledParty resides at a PBX deskphone and if that PBX is connected to the SSP using dedicated PRI/ISUP facilities, then if the Least Cost Routing (LCR) feature is enabled for the business group, then the VPN application will prefix the extension of the CalledParty with a routing prefix that will allow the call to be routed directly over dedicated PBX trunk group(s).

The disclosure also provides for interworking with any addressable communication(s) for billing purposes, as short-messages, multi-media messages, or data sent over VPN.

Indeed, these features and other such advantages of the present invention shall readily become apparent from the following description and accompanying drawings.

### BRIEF DESCRIPTION OF THE DRAWINGS

FIG. 1 details a non-limiting call-flow of a Mobile-to-Mobile Originated VPN Call which invokes the art of the disclosure of present;

FIG. 2 details a non-limiting call-flow of a Mobile-to-PBX Originated VPN Call which invokes the art of the disclosure of present;

FIG. 3 details a non-limiting call-flow of a PBX-to-Mobile Originated VPN Call which invokes the art of the disclosure of present;

FIG. 4 details a non-limiting call-flow of a PBX-to-PBX Originated VPN Call which invokes the art of the disclosure of present;

FIG. 5 details a non-limiting call-flow of a PBX (via the PSTN)-to-PBX Originated VPN Call which invokes the art of the disclosure of present;

FIG. 6 details a non-limiting call-flow of a PSTN-to-mobile (or PSTN) Originated VPN Call which invokes the art of the disclosure of present;

FIG. 7 details a non-limiting call-flow of a VPN Homezone IN Messaging scenario which invokes the art of the disclosure of present;

FIG. 8 details a non-limiting call-flow of a Successful Prepaid SMS-MO transaction by a VPN user which invokes the art of the disclosure of present;

FIG. 9 details a non-limiting call-flow of a Successful Postpaid SMS-MO transaction by a VPN user which invokes the art of the disclosure of present;

FIG. 10 details a non-limiting call-flow of a Successful Prepaid SMS-MT transaction by a VPN user which invokes the art of the disclosure of present;

FIG. 11 details a non-limiting call-flow of a Successful Postpaid SMS-MT transaction by a VPN user which invokes the art of the disclosure of present.

### DETAILED DESCRIPTION OF THE PREFERRED EMBODIMENTS

Members skilled in the art will recognize that the ensuing represents an illustrative recital of the preferred embodiments of the invention of present and other embodiments may be articulated, gleaned and articulated from such while still remaining with in its spirit and scope. Equivalents found within the state of the art, and those which may reasonably and effectively be deemed equivalent in the future should also be understood as being incorporated by reference hereto and such. Furthermore, much of the language has been illustrative and is to be construed as expressly for pedagogical purposes in helping elucidate the art as concisely and beneficially as practical. Indeed, articulated as part of a computer program product, the disclosure is best presented as a series of non-limiting, illustrative call-flows which provide for an easy elucidation of the art.

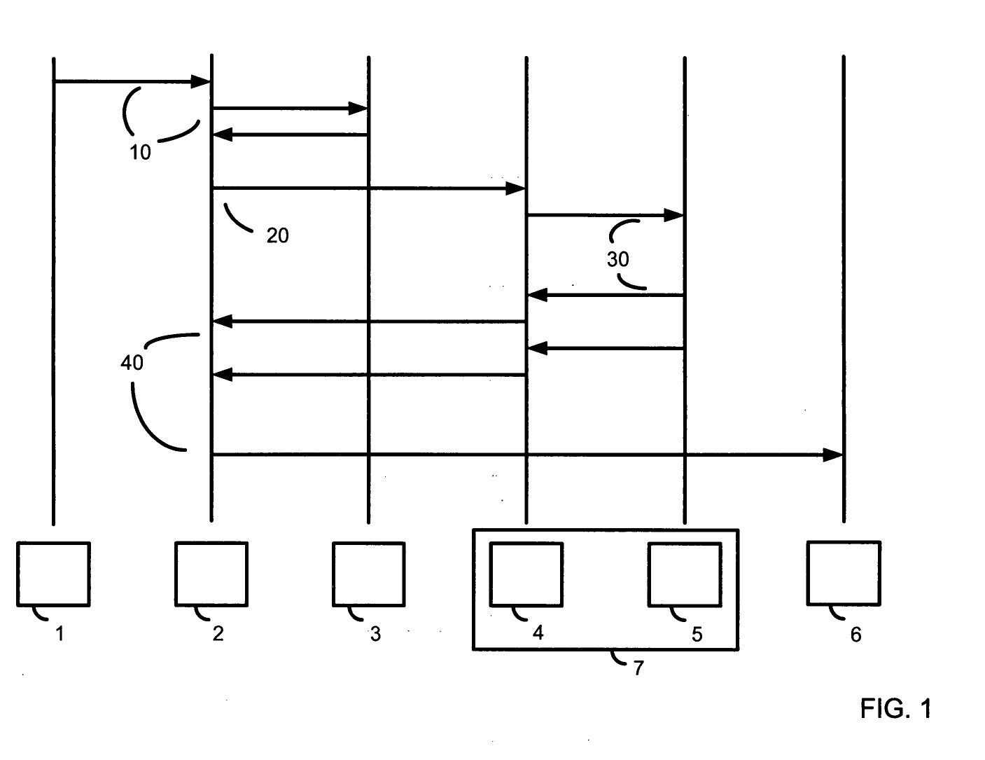

With reference to FIG. 1, the originating mobile subscriber 1 dials a code (1234 for instance) from her handset (or dials an enhanced code in front of the PBX deskphone extension) 10. Per usual telecommunication's routing the call is routed to the MSC SSP 2 and Home Location Register (HLR) (or Visitor Location Register (VLR) for roaming situations) 3. At 20 the subscriber 1 is ‘subscribed’ to DP-2 services, wherewith the call triggers at the DP-2 trigger and an InitalDP operation sent to the Call Control node 4 articulated within the invention 7. At 30, the core VPN module 5 of the invention 7 is invoked and VPN features are performed (detailed at length later). The VPN module 5 requests that billing information (e.g. setCallChargePlan method) is to be sent the MSC SSP 2 and attempts to route the call. Therewith at 40, the MSC SSP 2 receives the FurnishChargingInformation (FCI) operation (in this instance) and appends the billing information to the Call Detail Record (CDR). The Connect operation is received 40 and the call is routed to the terminating mobile subscriber 6.

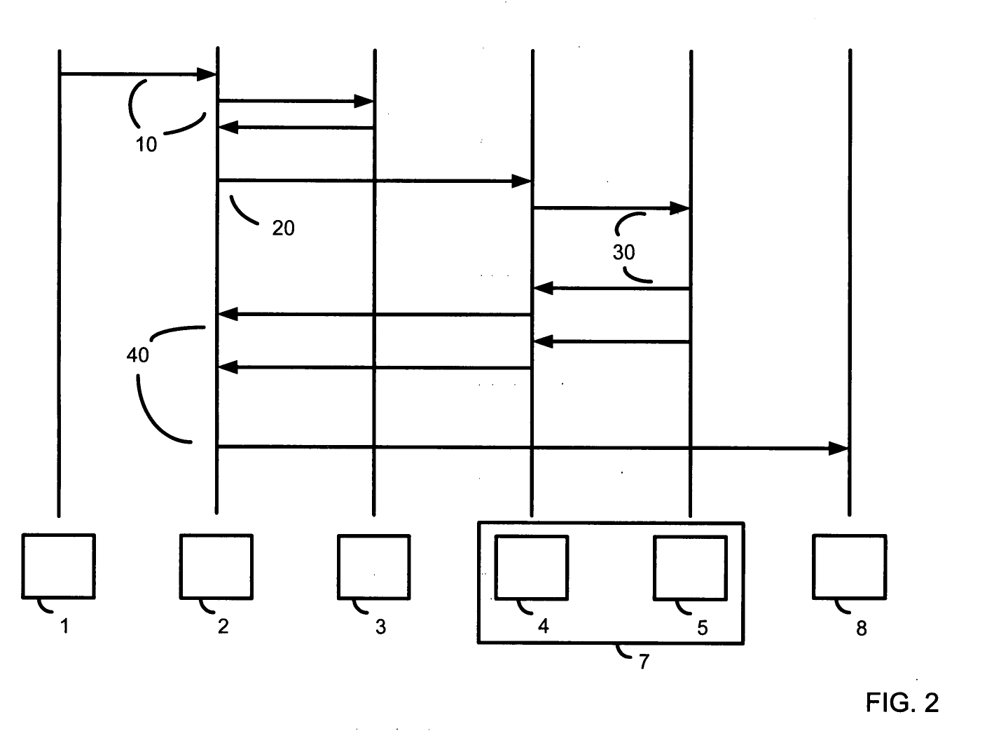

With reference to FIG. 2, the originating mobile subscriber 1 dials a code (1234 for instance) from her handset (or dials an enhanced code in front of the PBX deskphone extension) 10. Per usual telecommunication's routing the call is routed to the MSC SSP 2 and Home Location Register (HLR) (or Visitor Location Register (VLR) for roaming situations) 3. At 20 the subscriber 1 is ‘subscribed’ to DP-2 services, wherewith the call triggers at the DP-2 trigger and an InitalDP operation sent to the Call Control node 4 articulated within the invention 7. At 30, the core VPN module 5 of the invention 7 is invoked and VPN features are performed (detailed at length later). The VPN module 5 requests that billing information (e.g. setCallChargePlan method) is to be sent the MSC SSP 2 and attempts to route the call. Therewith at 40, the MSC SSP 2 receives the FurnishChargingInformation (FCI) operation (in this instance) and appends the billing information to the Call Detail Record (CDR). The Connect operation is received and the call is routed directly to the PBX 8 via dedicated trunk group.

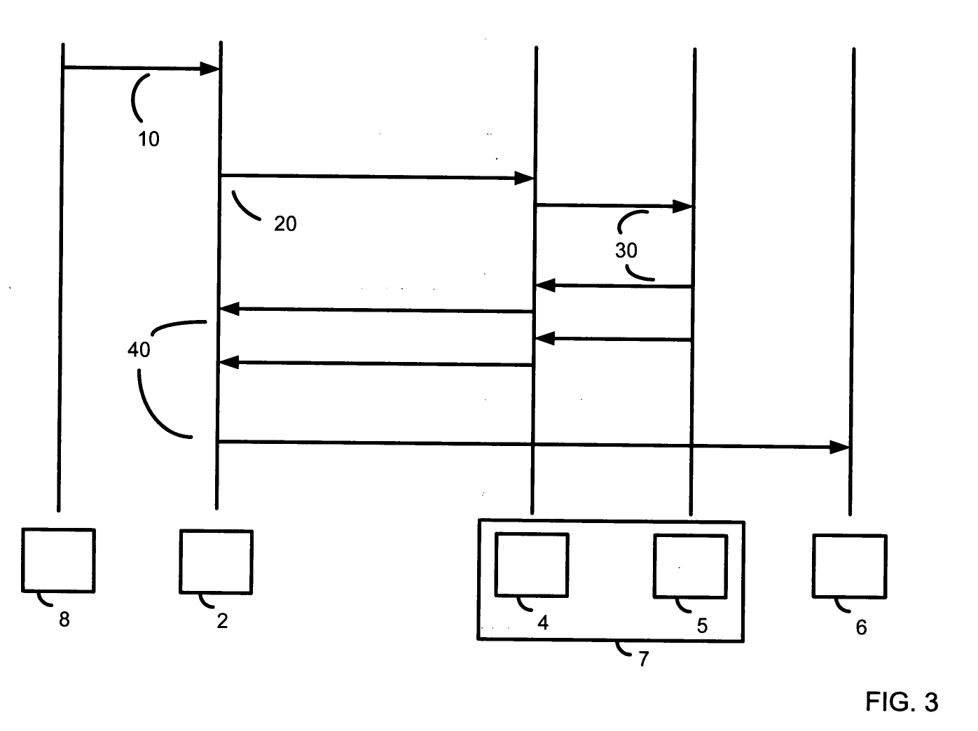

With reference to FIG. 3, the originating PBX user 8 dials a code (1234 for instance) from her PBX deskphone 10. Per usual telecommunication's routing the call is routed to the MSC SSP 2, where at 20 the PBX user's call triggers a DP-3 office trigger and an InitialDP operation sent to the Call Control node 4 articulated within the invention 7. At 30, the core VPN module 5 of the invention 7 is invoked and VPN features are performed (detailed at length later). The VPN module 5 requests that billing information (e.g. setCallChargePlan method) is to be sent the MSC SSP 2 and attempts to route the call. Therewith at 40, the MSC SSP 2 receives the FurnishChargingInformation (FCI) operation (in this instance) and appends the billing information to the Call Detail Record (CDR). The Connect operation is received and the call is routed to the terminating mobile subscriber 6.

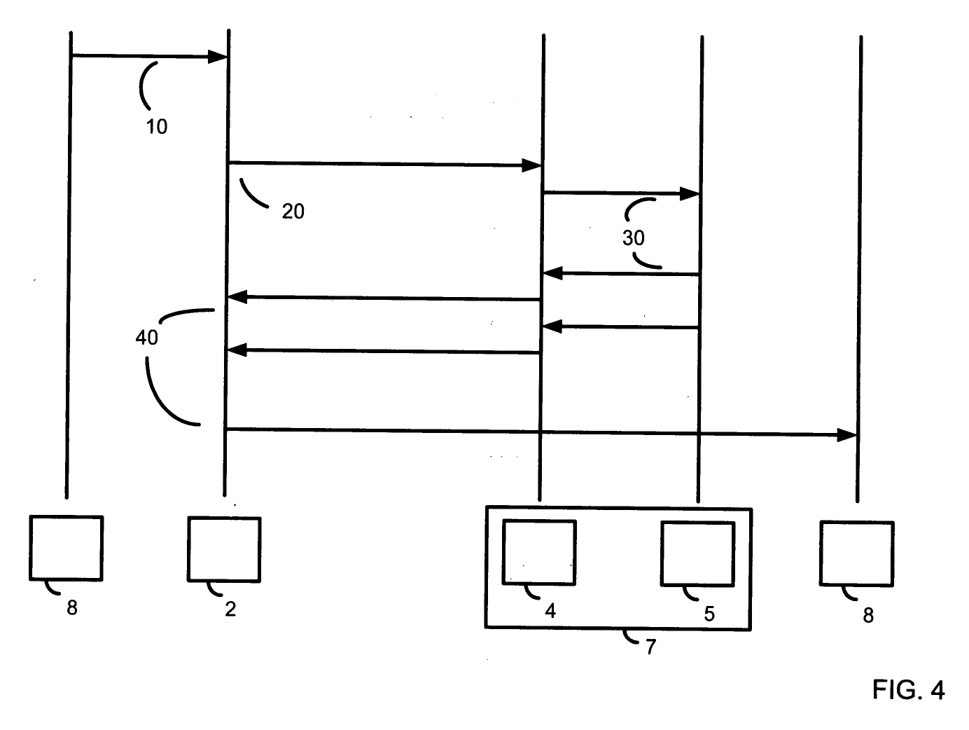

With reference to FIG. 4, the originating PBX user 8 dials a code (1234 for instance) from her PBX deskphone 10. Per usual telecommunication's routing the call is routed to the MSC SSP 2, where at 20 the PBX user's call triggers a DP-3 office trigger and an InitialDP operation sent to the Call Control node 4 articulated within the invention 7. At 30, the core VPN module 5 of the invention 7 is invoked and VPN features are performed (detailed at length later). The VPN module 5 requests that billing information (e.g. setCallChargePlan method) is to be sent the MSC SSP 2 and attempts to route the call. Therewith at 40, the MSC SSP 2 receives the FurnishChargingInformation (FCI) operation (in this instance) and appends the billing information to the Call Detail Record (CDR). The Connect operation is received and the call is routed directly to the PBX via dedicated trunk group 8

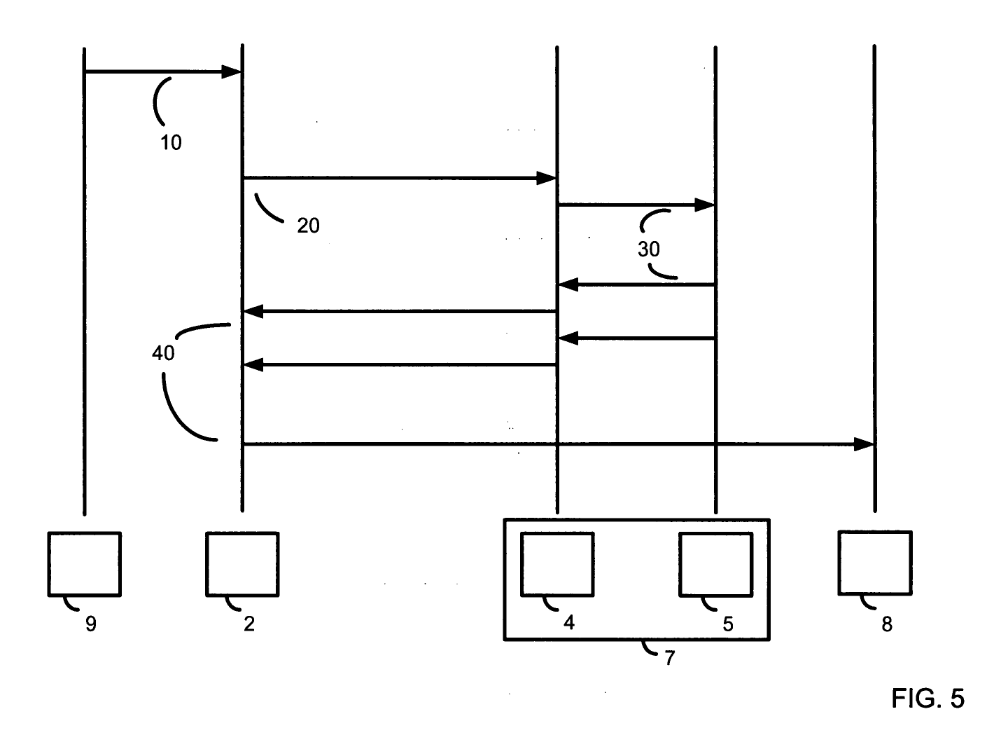

With reference now to FIG. 5, at 10 the originating VPN user dials her VPN Access code and 7777 (for instance) from the PSTN 9. Per usual telecommunication's routing the call is routed to the MSC SSP 2, where at 20 the PBX user's call triggers a DP-3 office trigger and an InitialDP operation sent to the Call Control node 4 articulated within the invention 7. At 30, the core VPN module 5 of the invention 7 is invoked and VPN features are performed (detailed at length later). The VPN module 5 requests that billing information (e.g. setCallChargePlan method) is to be sent the MSC SSP 2 and attempts to route the call. Therewith at 40, the MSC SSP 2 receives the FurnishChargingInformation (FCI) operation (in this instance) and appends the billing information to the Call Detail Record (CDR). The Connect operation is received and the call is routed directly to the PBX via dedicated trunk group 8.

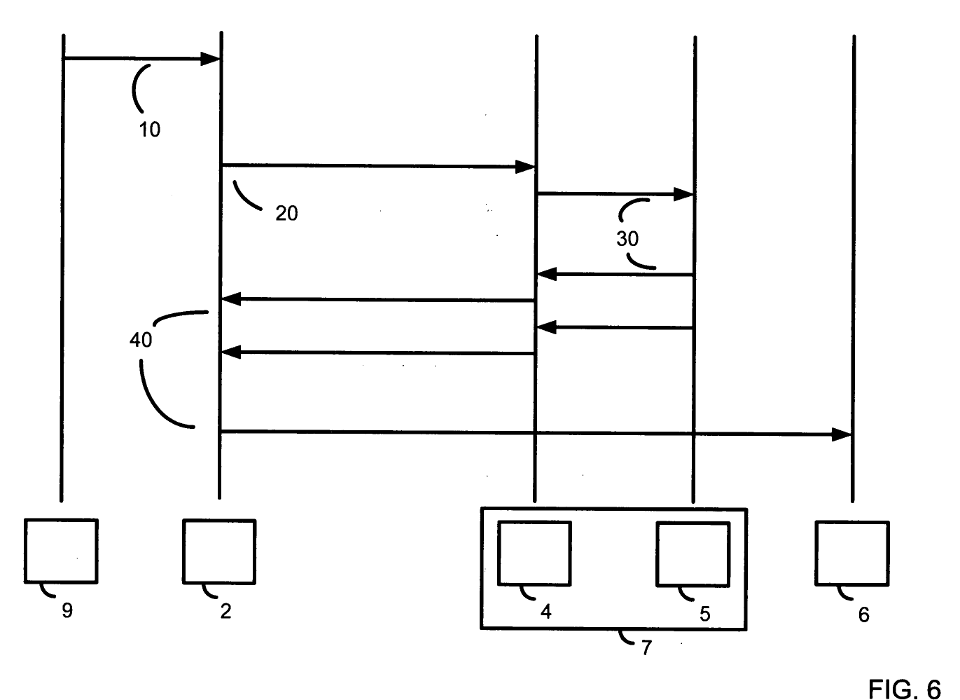

With reference to FIG. 6, at 10 the originating VPN user dials her VPN Access code and 7777 (for instance) and 1234 (for instance) from her PBX deskphone (not shown) from the PSTN 9. Per usual telecommunication's routing the call is routed to the MSC SSP 2, where at 20 the PBX user's call triggers a DP-3 office trigger and an InitialDP operation sent to the Call Control node 4 articulated within the invention 7. At 30, the core VPN module 5 of the invention 7 is invoked and VPN features are performed (detailed at length later). The VPN module 5 requests that billing information (e.g. setCallChargePlan method) is to be sent the MSC SSP 2 and attempts to route the call. Therewith at 40, the MSC SSP 2 receives the FurnishChargingInformation (FCI) operation (in this instance) and appends the billing information to the Call Detail Record (CDR). The Connect operation is received and the call is routed to the mobile subscriber 6 (or PSTN (not shown) for further routing).

Three access types are provided for in the disclosure of present, namely Mobile Access, Dedicated PBX Access and Public Access. The InitialDP servicekey determines the access type. The servicekeys for each access type are defined in the invention's logical memory store. And, once the access type is determined then the subsequent steps to determine the VPN user identity and associated business group id and site code will be different for each access type.

For instance, if the mobile Access servicekey is received in the InitialDP, then the CGPN is used to retrieve a record from the invention's internal memory store (the “VPN Origination Private DN Table”) to determine the BGid (and, in alternate embodiments, “dummy” SiteID when a site dial plan is used). If the VPN subscriber has initiated an SMS mobile origination and OCSI is subscribed to in the HLR then an InitialDP operation will be sent to the VPN application node. The invention's Call Control node will determine whether the incoming query is for an SMS-MO or a voice call and set the TeleService parameter accordingly in the CallEventNotify.

If the PBX dedicated access servicekey is received in the InitialDP, then the invention refers to its internally articulated table (the “PBX Dedicated Access Table”) for the schema that is used to determine the BG, and optional SiteID of the VPN originator. The Originating Node ID (ONI) must be prepended to the CDPN by the PBX, or by suitable MSC translations.

If the Public Access serviceKey is received in the InitialDP, then the invention determines that the call originated from a PBX via the PSTN. Depending upon the Public_Access_Mechanism configuration option that is configured within the logic of the invention, then either of the following tables may be used to retrieve the attributes associated with the originating PBX. The so-called “Public Access Code Table” uses the leading digits of the CDPN to determine the SPid, BGid, SiteCode of the originating PBX. Whereas the so-called “Public Access Pilot DN Table” uses the leading digits of the CGPN to determine the SPid, BGid, SiteCode of the originating PBX. (Both tables are also used to determine any overlap handling requirements, if applicable).

In anticipating that in alternate embodiments some transit networks may also prefix the CC before the VPN public access code which causes the Dp3 trigger to be encountered (e.g. CC+800XXXXXXX+YYYYY) where YYYYY is the extension digits dialed by the VPN user, then the DN normalization must be provisioned correctly so that any leading digits, which may exist before the extension, are deleted (i.e. CDPN is normalized) before the call can encounter further VPN processing.

The invention has been articulated to support a multitude of ‘called party number formats’. For OnNet calling, Extension Dialing, Enhanced Extension Dialing and Site Code Dialing are provided for. With Extension Dialing, users within the same business group can reach each other by dialing an extension (e.g. 5555). The extension length may be variable length per business group. Extensions can be 3-12 digits in length. For example, mobiles and desk phones can be grouped into an extension dial plan, such that a site code (see below) is not required to be dialed before the VPN user's extension. For Enhanced Extension Dialing, a caller can dial an access code before the extension and the call may be routed to alternate DN instead of the primary terminating DN associated with that extension. For example, a caller could dial 8-5555 and the call will be routed to the terminating group member's mobile handset. Enhanced Extension Access codes can be 1 or 2 digits in varying embodiments. For Site Code Dialing, when a business group has multiple sites, then a site code dialing may be implemented to simplify calls between sites. Intra-site calls may be placed without a site code (e.g. 23), however when one wants to reach a business group member located at a different site, then a site code must be dialed before the extension. Therefore, group members at different sites may have the same extension. Site codes are the same length within the Business Group and can be 1-5 digits in varying embodiments. In alternate embodiments, extension dialing may be selected when a Business group has multiple sites.

Now, for OffNet calling, in addition to the various private numbering plans that support OnNet calls, Offnet calls may be placed by dialing an OffNet access code followed by the public number. The business group may subscribe to the forced OnNet feature so that when OffNet dialed calls are placed, the calltype is reassigned as OnNet calls for billing purposes. Furthermore, for OffService calling, OffService access codes may be dialed before special numbers defined by the service provider and such calls will escape VPN processing by the invention and be assigned a calltype=OffService. This allows certain types of OffNet calls to be differentiated from normal OffNet calls.

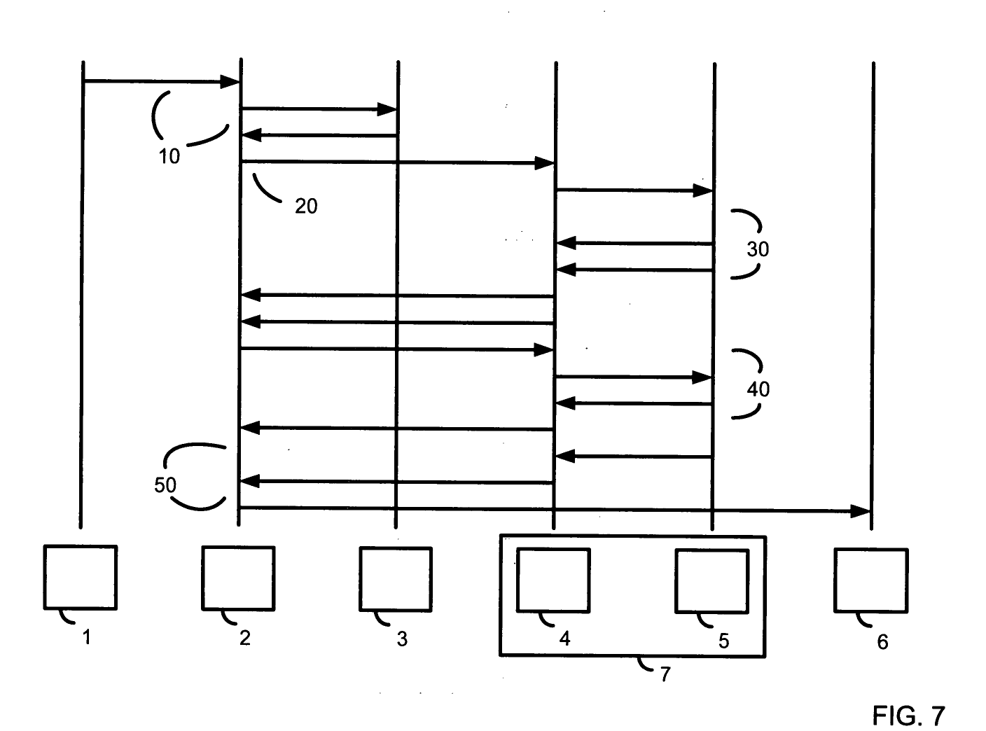

FIG. 7 also details the ‘homezone’ feature of the invention 7 which allows the telecommunication's service provider the ability to offer their VPN corporate customers differentiated billing based upon where their VPN group members place their calls from. More particularly, it demonstrates the interaction between the articulated ‘homezone ’ feature of the invention 7 and the MSC SSP 2 for the purpose of playing a specific announcement to the caller when they are in one of their specified zones. If the user 1 is outside of any provisioned zone then either no tone is played at all, or a different distinct tone or message indicating such. In advancing the art, therefore, when a subscriber originates a voice call from one of their Homezone locations the call may be billed at a lower rate than when they originate a call from outside one of their ‘homezone’ locations.

Continuing then with reference to FIG. 7, the originating mobile subscriber 1 dials a code (1234 for instance) from her handset (or dials an enhanced code in front of the PBX deskphone extension) 10. Per usual telecommunication's routing the call is routed to the MSC SSP 2 and Home Location Register (HLR) (or Visitor Location Register (VLR) for roaming situations) 3. At 20 the subscriber 1 is ‘subscribed’ to DP-2 services, wherewith the call triggers at the DP-2 trigger and an InitalDP operation sent to the Call Control node 4 articulated within the invention 7. At 30, the core VPN module 5 of the invention 7 is invoked and VPN features are performed. The VPN module 5 requests that billing information (e.g. setCallChargePlan method) is to be sent the MSC SSP 2 and attempts to route the call. At 40 the core VPN module 5 of the invention 7 determines that the subscriber is located in one of their provisioned zones, and then requests that the appropriate tone is played to the mobile VPN originator 1 as an indicator as to what tariff rate will be used for this call. Then at 50, the core VPN module 5 of the invention 7 requests an FCI operation to be sent to the MSC SSP, which appends the IN billing information to the Call Detail Record. The Connect operation is received 40 and the call is routed to the terminating mobile subscriber 6.

The invention has also been articulated to support the ability to allow members of a business group to dial each other using extension dialing. Therefore, from a PBX deskphone, calls can be placed to other PBX deskphones, mobile handsets, or PSTN DNs using an abbreviated extension number, for example. In alternate embodiments, extension dialing is also available to mobile handsets.

The invention has been articulated to support both extension dialing (caller dials extension (i.e. 3-12 digits), or caller dials an OnNet Access Code+extension), and/or site dialing (caller dials extension (within same site), caller dials SiteCode+extension, caller dials an OnNet Access Code+Site Code+extension (where the SiteCode=1-5 digits, extension=3-12 digits)).

A VPN user need only dial an extension to reach a member of the same business group at the same site. In other embodiments however, a VPN user dials a Site Code+extension to reach a member of the same business group at a different site. In still further embodiments, a VPN user may still dial their own site code+extension, if they want to reach a user at the same site. If an extension dial plan is chosen for the business group, then all members of that business group use the extension dial plan. If a site dial plan is chosen for the business group, then all members of that business group use the site dial plan.

The Business Group also defines whether there will be an access code, and if so whether as OffNet, OnNet or OffService access code(s).

When the OffNet access code is dialed before a public number, it is stripped, the called number is normalized, and the calltype is assigned to be offNet (the calltype is defined in the FCI billing item).

Whereas with respect to the OnNet access code, where it is dialed before an extension, or a SiteCode+extension, then it is stripped before the remaining private number is translated to a public number using the parameters provided for in the pre-defined tables. After the DN is translated to a public number, it is normalized according to the DN normalization feature (just prior to routing). In alternate embodiments, the private numbering plan may be setup so that an access code is dialed for OnNet calls, and OffNet calls are dialed without an access code. In such cases, all public numbers must exceed the length of the longest private number (including any required access codes). Offnet calls and OnNet calls may be placed without dialing an access code. In such cases, the MinPrivDN_Length is used to differentiate OffNet calls from OnNet calls. OffNet dialed calls are still normalized by the DN normalization feature.

Now, when the OffService code is dialed before the destination DN then the OffService code is stripped and the destination DN is returned to the MSC SSP unchanged. The OffService access code may be used for certain inter-PLMN private networking purposes, or even perhaps when a Freephone or Premium rate number is dialed that should not be normalized. The calltype is set to offService.

The Voice Mail Access aspect of the disclosure allows a caller to dial their own extension or Public DN (if the Forced OnNet feature is enabled) and the call is routed to their voice mailbox. This feature allows calledparty number manipulation to be performed so that special switch-based translations that route the call to the correct voice mail platform is not required. When a caller dials their own extension, or public number (if forced OnNet is enabled) then a check is made to see whether the public number of the caller is the same as the public number of the calledparty. If they are the same, then the called party number derived is the voice mail access number. The calltype for voice mail access is defined within the invention's logical memory store. The Voice Mail DN must be provisioned in E.164 International format.

Indeed, it remains another feature of the disclosure to provide art directed at Directory Number (DN) Normalization. DN Normalization (direction=incoming) is performed to normalize the CDPN to a specific format (i.e. E.164 International format) so that VPN application processing may be performed. It is also performed (direction=outgoing) in order to format the CDPN into the correct format for the MSC SSP. DN Normalization occurs in a rule based manner. In the preferred embodiment, the first applicable rule matched will be utilized for normalization. After a VPN call has been placed, the called party number (if a public number has been placed) are normalized to an E.164 International DN before further VPN call processing can be performed. (The CGPN is normalized using another procedure. If the CC is not at the beginning of the CGPN then the CC value configured in the VPNAppConfig.xml file will be prefixed to the leading CGPN digits). DN normalization is performed after any access code codes (e.g. Personal Account Access code, OffNet access code) have been stripped away. If a match is not found in the DN Normalization Table (illustrated in Table 1, provided forthwith) then processing/routing continues using the existing CDPN value. The DN Normalization Table includes a Direction field that is required to be provisioned. In various embodiments, this may take on several values, namely ‘incoming’ (the CDPN is normalized for the DN screening feature, and for the Forced OnNet feature), ‘outgoing’ (the CDPN is normalized before call routing (for both OffNet calls, and OnNet calls which have been translated and which are not being routed over dedicated trunk groups), or ‘any’ (the required normalization is performed in both directions). For ease of reference, Table 1 has been provided to represent a non-limiting, illustrative embodiment of said rules employed in normalizing CDPNs to E.164 International format.

TABLE 1
Illustrative DN Normalization Table

| Dialed Number | Action (example) |
|---|---|
| 0 + NDC + SN | Strip 0, add CC |
| 00 + CC + NDC + SN | Strip 00 |
| 0 + CityCode + SN | Strip 0, Prefix CC |
| 011 + CC + NDC + SN | Strip 011 |
| 1 + NPA-NXX-XXXX | Strip 1 |
| NPA-NXX-XXXX | Do nothing |
| NXX-XXXX | Prefix NPA, Prefix CC (1) |

Other advantages of the invention remain aimed at disclosing relevant art for cost-minimization, and include the ability for the business group to establish a business relationship with another business group such that offnet dialed calls between these two different organizations are billed at a reduced rate. The invention may also be articulated with Class Of Service (COS) Restrictions. A COS is a calling privilege level that may be assigned to each private number. A caller is permitted to place any outgoing call as long as their assigned class of service is greater than or equal to the required call restriction level. The initial call restriction level is defined in the invention's logical memory store (the “Restriction Configuration Logic”). Call restriction levels are further refined during regular call processing. For example, when the initial call restriction level is set to 0, it may be increased to 5 after business hours so that VPN users may only make VPN postpaid calls if their class of service is 5 or more. Per internally articulated tables and programmatic instructions (e.g. “VPN Screening Table” and/or “VPN Time Based Screening Table”), when the ActionToPerform is PerformCOSCheck, then at this point the originator's COS is compared with the prevailing call restriction level. If the COS is greater than or equal to the COS, then the call is immediately routed. If the COSCheck fails and the COS is less than the call restriction level, then the call is immediately released with a configurable cause value defined in the Restriction Configuration Logic.

Another salient aspect of the disclosure provides for forced OnNet calling. Indeed, most mobile handsets issued by business groups include a SIM-based company directory in public number format. When such public calls are placed amongst members of the same business group, such calls should not be tariffed as OffNet calls, rather they should be tariffed as OnNet calls. The invention determines when a calling party number and called party number are within the same business group and tariffs such calls as OnNet. After a VPN call is placed, if the caller has dialed a public number and the business group has subscribed to the Forced OnNet feature then a check is performed (on CC+NDC) to see whether a mobile DN has been dialed. If a mobile DN has been dialed and an entry is located within the invention's logical memory store (e.g. the “VPN Origination Private DN Table”) then the calltype is set to OnNet. Otherwise, if the terminating DN is not identified to be a mobile DN and FON is subscribed, then a lookup is performed within the “Public Range Translation Table” (illustrated in Table 2, provided forthwith). If an entry is found in this table then reverse translation to the extension is performed according to how the entry is provisioned. During FON processing, the SiteIDType is used to determine whether the call should be routed using the original dialed digits, or whether to route the call using the Least Cost Routing (LCR) feature (described below after Table 2).

TABLE 2
Illustrative Public Range Translation Table

| Field Name | Type | Description |
|---|---|---|
| SPid | NUMBER(2, 0) | The Service Provider ID to which |
| | | this public range belongs. |
| BGID | NUMBER(9, 0) | The business group to which the |
| | | VPN user belongs. |
| SiteCode | VARCHAR2(5) | The site code that this VPN user |
| | | belongs to (if applicable). |
| Number | NUMBER (2, 0) | The number of digits to delete |
| Leading | | from the leading digits of the |
| Digits To | | called party number for a match |
| Delete | | within this range. |
| Extension | VARCHAR2(20) | The prefix digits to be used |
| Prefix | | after any leading digits have |
| Digits | | been deleted. |
| Non-DID Flag | BOOLEAN | This field indicates whether the |
| | | range of public numbers have |
| | | direct inward dialing (DID). |
| | | This may be set to TRUE or FALSE. |
| Non-DID Pilot | VARCHAR2(20) | If the range of public numbers |
| Extension | | do not support direct inward |
| | | dialing (DID) then calls will be |
| | | routed to the terminating DN |
| | | (e.g. corporate directory admin- |
| | | istrator) using this default |
| | | extension. |
| Public Number | VARCHAR2(22) | This field is used by the FON |
| Lower Bound | | feature to define the lower |
| | | bound of the public number range. |
| Public Number | VARCHAR2(22) | This field is used by the FON |
| Upper Bound | | feature to define the upper |
| | | bound of the public number range. |

Those practicing the invention may wish to have some calls charged against a prepaid account, rather than billed against a company postpaid account. For instance, where a personal account access code is dialed, the call may be charged against an individual's prepaid account rather than being charged as a postpaid business call. Other non-exhaustive call scenarios that may result in the call being charged against an individual's prepaid account may include situations where a VPN user makes any outgoing OffNet call outside business hours, or a VPN user places an International OffNet call. When a prepaid account billing number has been provisioned and is assigned during VPN call processing, then call processing will be transferred to the invention's prepaid component(s) when VPN Action=“Route Immediately” (for instance), or no other features are to be performed. In the preferred embodiment, said prepaid aspect of the invention is performed when no other VPN feature actions are to be performed (but not necessarily so, of course). After the invention has invoked it's internally articulated Call Control Service to send the FCI operation to the SSP, call processing is handed over to the prepaid application aspects of the disclosure. The “RkIpCall::handover” method is invoked by the invention in order to initiate handover to it's prepaid component. The following non-limiting, non-exhaustive parameters which may be passed in the handover method call include, Call Session ID, Bearer capability, High layer compatibility, Service key (required for retriggering), CGPN NOA, CGPN Digits, CDPN NOA, CDPN Digits, RedirectingPartyID (if available), LocationNumber (if available), Billing number (i.e. prepaid account number), Call event type (P_ORIGINATING, P_TERMINATING), Application ID (i.e. VPN), and MNP Routing Prefix.

The invention has also been designed to provide for interworking with any addressable communication(s) for billing purposes (as short-message service (SMS) messages, multi-media service (MMS) messages, or data sent over VPN). Although the ensuing remains quite SMS-centric in its ambit, skilled practitioners in the art will recognize that all of its teachings may be applied to network elements which relate to MMS messages by substitution of appropriate network elements and related art. (Our patent application Ser. No. 10/461,485 entitled “Improved Method and System for Multimedia Messaging Service (MMS) Rating and Billing” details much of the art relating to such billing practices). Likewise, the teachings in respect of SMS technologies herewith may also be applied generally to data streams, in consideration of and in conjunction with, the art taught by our patent application Ser. No. 10/348,972 entitled “Method for implementing an Internet Protocol (IP) charging and rating middleware platform and gateway system”.

The invention detailed in patent application Ser. No. 10/353,995 entitled “Improved Method and System for Short Message Service (SMS) Rating and Billing”, has a special ServiceGrade ‘SMS VPN’ to identify that a subscriber is a VPN customer. When this service grade is put into practice, the invention detailed in Ser. No. 10/353,995 uses a synchronous CORBA based Process_VPN_SMS_Transaction Method to retrieve additional values to perform rating based on time, OffNet or OnNet, business or personal, VPN prepaid or postpaid. When said invention Ser. No. 10/353,995 receives a submit_sm message from the serving MSC or ESMEs, it performs a lookup in its internal database using the MSISDN, and where the ServiceGrade is ‘SMS VPN’ (for instance), then a CORBA method call to the disclosure of present will be performed. (Practitioners skilled in the art shall recognize that a variety of object oriented application programming interfaces will satisfy the implementation of said architecture without affecting the intent and scope of the present invention).

Then, if the SMS is permitted, the Process_VPN_SMS_Transaction Method returns a ‘Transaction Allowed’ result, then the invention of present determines whether it is a prepaid (i.e. personal) or postpaid SMS transaction. For a prepaid VPN user, the invention detailed in patent application Ser. No. 10/353,995 will perform rating, BalDeduct only (no BalQuery) on submit to the SMS-C; whereas for a postpaid VPN user, the invention of present will allow message to be submitted. When a CDR is returned by the SMSC indicating successful delivery, invention of Ser. No. 10/353,995 will ‘call’ the disclosure of present and generate an ER indicating successful delivery.

The invention detailed in patent application Ser. No. 10/353,995 would then relay the short message to the SMS-C using SMPP submit_SM command.

Thereafter, when the SMS-C delivery CDRs are post-processed by said Ser. No. 10/353,995, each MSISDN is retrieved from said invention Ser. No. 10/353,995 internally articulated subscriber database to see whether the serviceGrade=‘SMS VPN’. If so, then the Process_VPN_SMS_Transaction is invoked for a second time to determine prepaid/postpaid indication using the originating SMS transaction time. If postpaid indication is returned from the disclosure of present then a final event record is generated and will be used to bill the customer in question.

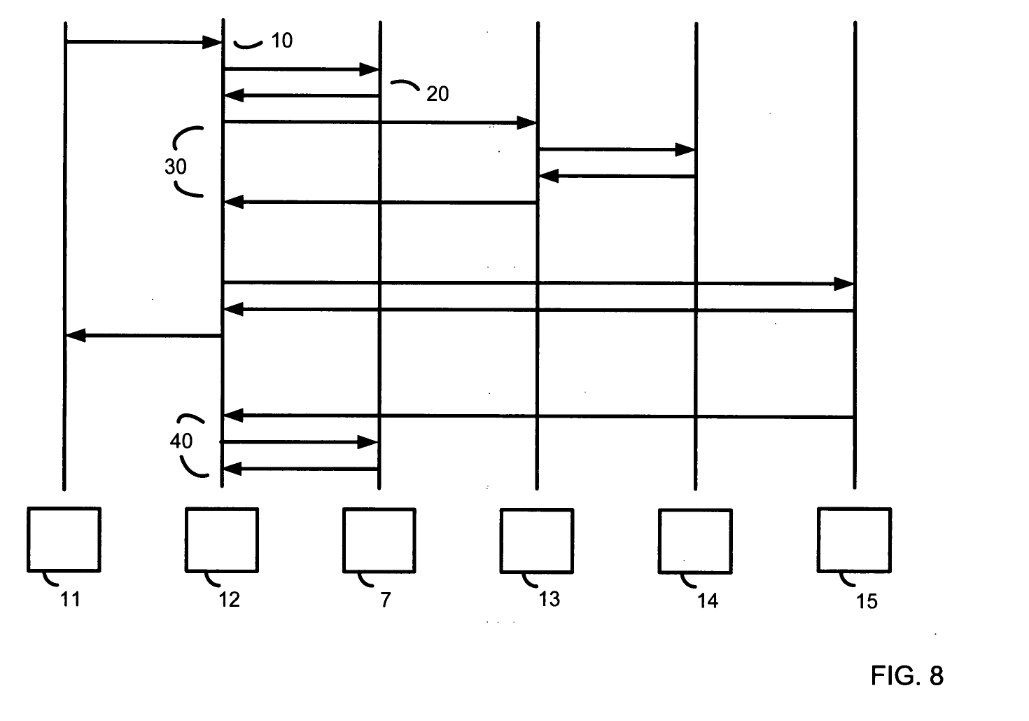

With reference to FIG. 8, at 10 upon the subscriber originating the SMS 11, a lookup is performed in the invention disclosed in patent application Ser. No. 10/353,995 entitled “Improved Method and System for Short Message Service (SMS) Rating and Billing” 12 using ‘A-Party’ MSISDN. (As detailed prior) if ServiceGrade indicates a VPN user Process_VPN_SMS_Transaction Method is called. At 20, Process_VPN_SMS_Transaction Method returns prepaid VPN between the Ser. No. 10/353,995 invention 12 and the invention of present 7. At 30, the rating functionality disclosed in invention Ser. No. 10/353,995 is performed and is billed upon submission to a charging product as that disclosed in patent application Ser. No. 10/307,335 entitled “Improved method for implementing an Open Charging (OC) middleware platform and gateway system” 13 to the SCP 14 (with no BalQuery). Then at 40, CDR information is forwarded from the SMSC 15, and if it indicates successful delivery, the Ser. No. 10/353,995 invention 12 does a ServiceGrade lookup, and VPN user Process_VPN_SMS_Transaction Method on ‘A-Party’. The Method returns prepaid VPN again ending processing.

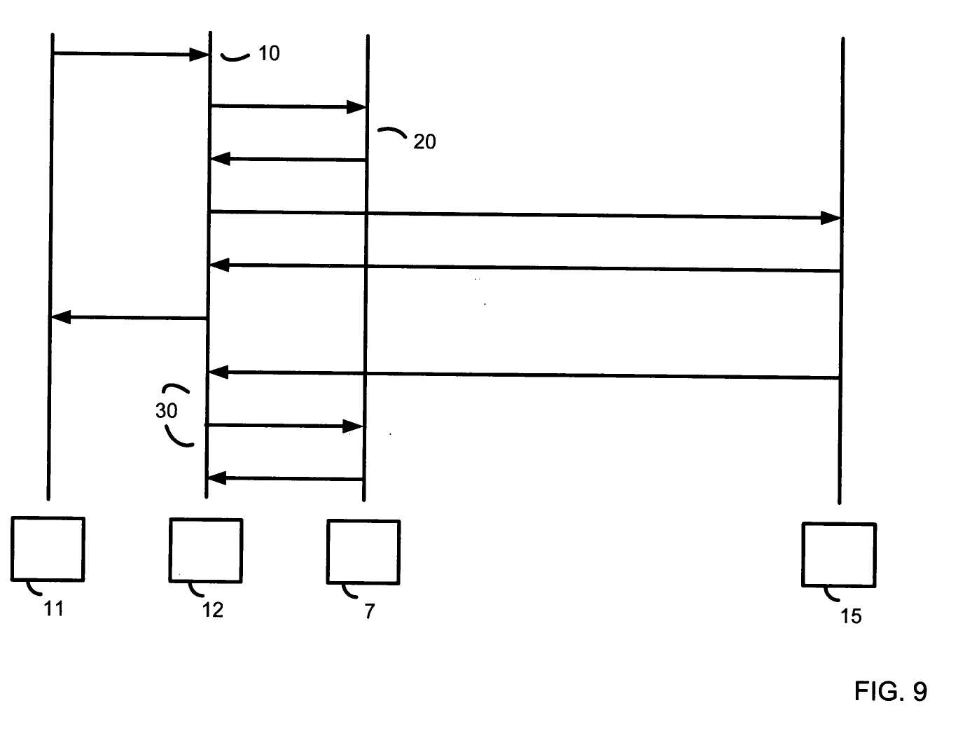

With reference now to FIG. 9, at 10 upon the subscriber originating the SMS 11, a lookup is performed in the invention disclosed in patent application Ser. No. 10/353,995 entitled “Improved Method and System for Short Message Service (SMS) Rating and Billing” 12 using ‘A-Party’ MSISDN. (As detailed prior) if ServiceGrade indicates a VPN user Process_VPN_SMS_Transaction Method is called. At 20, Process_VPN_SMS_Transaction Method returns postpaid VPN between the Ser. No. 10/353,995 invention 12 and the invention of present 7. At 30, the CDR is forwarded from the SMSC 15. If the CDR indicates successful delivery, the Ser. No. 10/353,995 invention 12 does a ServiceGrade lookup, and VPN user Process_VPN_SMS_Transaction Method on ‘A-Party’. The Method returns postpaid VPN again and the Ser. No. 10/353,995 invention 12 rates and generates an ER accordingly (as per that patent application's specification).

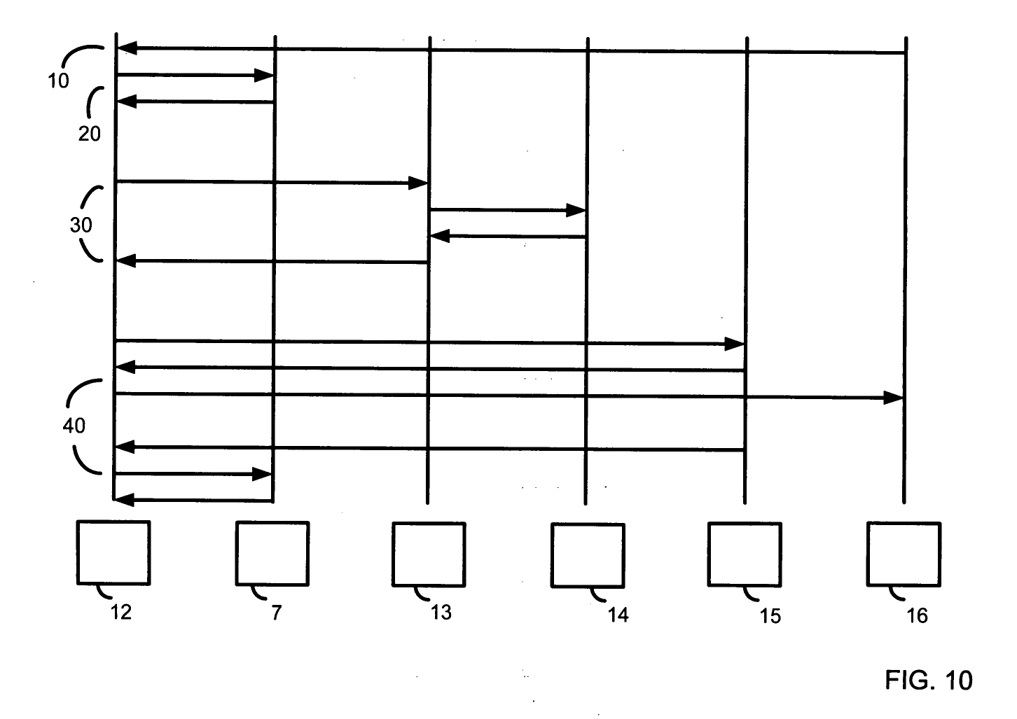

With reference now to FIG. 10, at 10 a lookup is performed in the invention disclosed in patent application Ser. No. 10/353,995 entitled “Improved Method and System for Short Message Service (SMS) Rating and Billing” 12 using ‘B-Party’ MSISDN (the ESME is represented at 16). (As detailed prior) if ServiceGrade indicates a VPN user Process_VPN_SMS_Transaction Method is called. At 20, Process_VPN_SMS_Transaction Method returns prepaid VPN between the Ser. No. 10/353,995 invention 12 and the invention of present 7. At 30, the rating functionality disclosed in invention Ser. No. 10/353,995 is performed and is billed upon submission to a charging product as that disclosed in patent application Ser. No. 10/307,335 entitled “Improved method for implementing an Open Charging (OC) middleware platform and gateway system” 13 to the SCP 14 (with no BalQuery). Then at 40, CDR information is forwarded from the SMSC 15 (a response is also sent to the ESME 16), and if it indicates successful delivery, the Ser. No. 10/353,995 invention 12 does a ServiceGrade lookup, and VPN user Process_VPN_SMS_Transaction Method on ‘B-Party’. The Method returns prepaid VPN again ending processing.

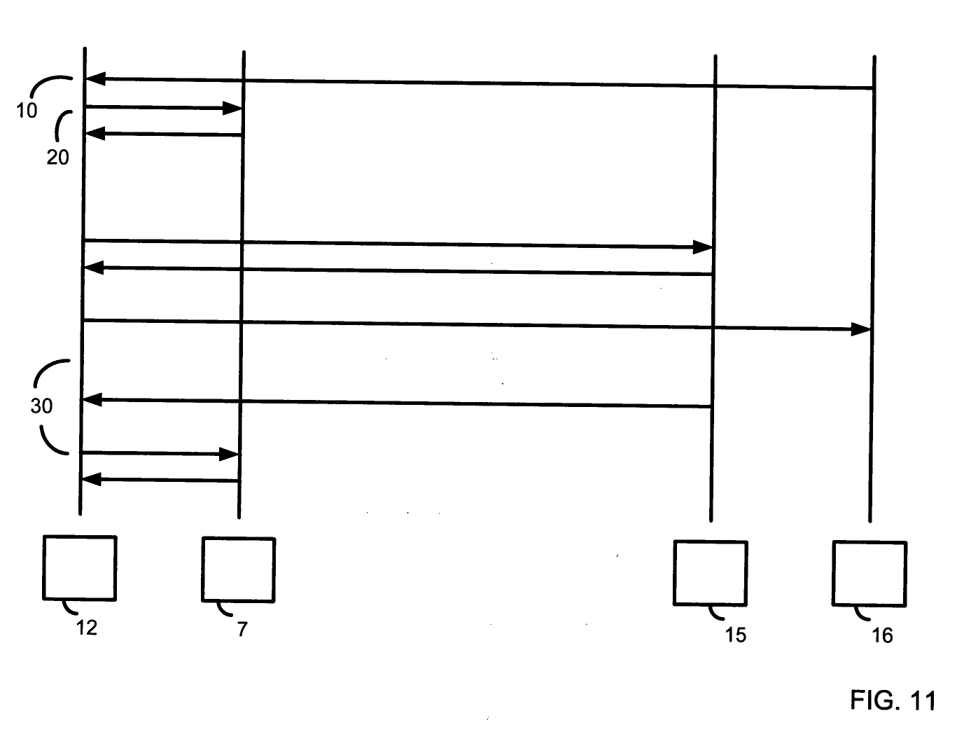

With reference then to FIG. 11, at 10 a lookup is performed in the invention disclosed in patent application Ser. No. 10/353,995 entitled “Improved Method and System for Short Message Service (SMS) Rating and Billing” 12 using ‘B-Party’ MSISDN (the ESME is represented at 16). (As detailed prior) if ServiceGrade indicates a VPN user Process_VPN_SMS_Transaction Method is called. At 20, Process_VPN_SMS_Transaction Method returns postpaid VPN between the Ser. No. 10/353,995 invention 12 and the invention of present 7. Then at 30, CDR information is forwarded from the SMSC 15 (a response is also sent to the ESME 16), and if it indicates successful delivery, the Ser. No. 10/353,995 invention 12 does a ServiceGrade lookup, and VPN user Process_VPN_SMS_Transaction Method on ‘B-Party’. The Method returns postpaid VPN again and the Ser. No. 10/353,995 invention 12 rates and generates an ER accordingly (as per that patent application's specification).

Practitioners skilled in the art will appreciate, in respect of the disclosure, that the reliance upon, and cross-reference to, other patent applications merely serves to ease and aid in the instruction of the art being taught herewith. And indeed, equivalent concepts, technologies and inventions may well be employed without detracting or diluting from the scope of the disclosure of present.

The embodiments of the invention in which an exclusive property or privilege is claimed are:

1. An open architecture system for the provision of a converged wireless/wireline Virtual Private Network (VPN) messaging solution, which involves the facilitation of communication(s) among members of a large group of subscribers whereby they may reach one another by dialing private dial plan extensions from either a mobile handset, PBX extension, or from the PSTN.

2. The system of claim 1, whereby groups include business groups, or any similar such groups.

3. The system of claim 1, where said messaging includes any addressable communications.

4. The system of claim 3, where said addressable communications include voice, SMS, MMS and data flows.

5. The system of claim 1, whereby the invention exists as part of a computer program product, comprising:
a) a computer readable memory medium; and
b) a computer program including the mathematic and programmatic logic required to facilitate the steps, methods and rules as such.

6. The system of claim 5, whereby the invention is activated by triggers per the ordinary routing of the telecommunication(s) to the terminating subscriber or terminating device or terminating database or terminating network element (as the case may be).

7. The system of claim 6, which relates to the facilitation of SMS, MMS and/or data stream rating and/or billing within VPNs.

8. The system of claim 7, where network billing and/or rating elements perform checks to determine if the wireless subscriber is a member of the VPN.

9. The system of claim 8, where such checks include use of MSISDN, inter alia.

10. The system of claim 8, where such billing and/or rating elements may include functionalities disclosed in patent application Ser. No. 10/353,995, and/or patent application Ser. No. 10/461,485 and/or patent application Ser. No. 10/348,972.

11. The system of claim 8, where subscriber is determined to be a member of said VPN, the computer program product determines whether postpaid or prepaid transaction.

12. The system of claim 11, where the customer is a prepaid VPN subscriber the computer program product relays the relevant telecommunications, data and/or call information to the downstream billing and/or rating element(s).

13. The system of claim 12, where the customer is a postpaid VPN subscriber the computer program product allows the telecommunications, data and/or call information to be submitted, and awaits for the relevant call data record and/or confirmation message indicating successful delivery to the relevant network element, whereupon the relevant downstream billing and/or rating element(s) calls the computer program product to indicate said successful delivery.

14. The system of claim 13, where said call to the computer program product may generate an event record (or similar) to indicate said successful delivery.

15. The system of claim 14, where the relevant downstream billing and/or rating element(s) sends a confirmation to it's related network element to route the addressable media (whether voice, SMS, MMS or data flows) as appropriate.

16. A method for cost-reduction among wireless VPN users/subscribers which allows members of a business group to reach one another by dialing private dial plan extensions from either a mobile handset, PBX extension, or from the PSTN; or alternatively, where the public number of other VPN business group members are programmed into the wireless handset's SIM, the method (articulated as part of a computer program product) can recognize that the dialed number is an OnNet number (i.e. within the same business group) even though the public number of the CalledPartyNumber was received whereof in such cases, these calls attract a differentiated tariff rate (e.g. lower) from the service provider, furthermore, as when the call is an OffNet call (i.e. call placed to someone outside the caller's business group) then the calltype is set to OffNet, thereby typically attracting rates more expensive than OnNet calls.
